(19) United States
(12) Patent Application Publication
(10) Pub. No.: US 2019/0183292 A1
(43) Pub. Date: Jun. 20, 2019

(54) METHOD FOR APPLYING A TRACTION COATING TO A BATHING IMPLEMENT

(71) Applicant: Nathan Bishop, Spokane, WA (US)

(72) Inventor: Nathan Bishop, Spokane, WA (US)

(21) Appl. No.: 16/190,092

(22) Filed: Nov. 13, 2018

Related U.S. Application Data
(60) Provisional application No. 62/607,105, filed on Dec. 18, 2017.

(51) Int. Cl. A47K 3/024; B05D 5/02; B05D 3/02; B05D 7/00

(52) U.S. Cl. CPC A47K 3/024; B05D 7/586; B05D 3/0254; B05D 5/02

(57) ABSTRACT

A method for applying a traction coating to a bathing implement; the method involves providing a bathing implement. The bathing implement may be prefabricated and of any dimensions. At least one surface of the bathing implement is cleaned with a cleaning agent. The cleaning involves removing any particulates that may be on the surface of the bathing implement. A stencil is secured to the surface of the bathing implement that had been cleaned of any debris and particulate matter. A base coat of silicon rubber may then be applied to the surface. The base coat applied may not be less than 1 millimeter thickness and may not exceed 4 millimeters of thickness. The base coat of silicon rubber may then be cured from a liquid state to a substantially solid state.

### CROSS-REFERENCE TO RELATED APPLICATION(S)

The present application is related to and claims priority to U.S. Provisional Patent Application No. 62/607,105 filed Dec. 18, 2017, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of surface coatings of existing art and more specifically relates to a traction coating application.

### RELATED ART

Presently bathing implements such as showers and bathtubs are made with a glazed enamel surface. The glazed enamel surface is not porous and provides no traction when wet. The lack of traction on conventional bathing implements is problematic. A person may sustain serious injuries by slipping in their designated bathing area. Slipping on the surface of a shower or bathtub is a fear that many people who live alone have, more specifically the elderly. A suitable solution is desired.

Existing removable surface covers may be used but are not often practical. The removable surface covers generally comprise of a material that may provide traction to a person in a bathtub or shower, such as rubber or plastic. These surface covers are placed over a limited surface area of the bathing implement, and subsequently removed after bathing is complete. The surface covers may not be reliable and introduce an additional tripping hazard if not placed and secured properly. Further methods for adding traction may be incomplete or cost prohibitive.

U.S. Pat. No. 9,868,862 to Jia Liu relates to a surface coating system and method of using surface coating system. The described surface coating system and method of using surface coating system includes a coating system for a surface (such as a floor) including a liquid adhesive layer composition including a heat-activated adhesive that forms an adhesive layer upon drying after application to a surface, and a liquid maintenance layer composition comprising a dispersible polymer that forms a maintenance layer upon drying after application to the adhesive layer. The adhesive layer and the maintenance layer may form a peelable coating. An adhesive strength between the adhesive layer and the maintenance layer may be greater than an adhesive strength between the adhesive layer and the surface. The peelable coating may have a tensile strength that is greater than the adhesive strength between the adhesive layer and the surface. The peelable coating may be configured to be peeled from the surface without the adhesive layer and the maintenance layer separating from one another.

### SUMMARY OF THE INVENTION

In view of the foregoing disadvantages inherent in the known traction coating application art, the present disclosure provides a novel method for applying a traction coating to a bathing implement. The general purpose of the present disclosure, which will be described subsequently in greater detail, is to provide an effective and efficient method for applying a traction coating to a bathing implement.

A method for applying a traction coating to a bathing implement is disclosed herein. The method involves providing a bathing implement. The bathing implement may be prefabricated and of any suitable dimensioning. At least one surface of the bathing implement is cleaned with a cleaning agent. The cleaning involves removing any particulates that may be on the surface of the bathing implement. A stencil is secured to the surface of the bathing implement that had been cleaned of any debris and particulate matter. A base coat of silicon rubber may then be applied to the surface. The base coat applied may not be less than 1 millimeter in thickness and may not exceed 4 millimeters of thickness. The base coat of silicon rubber may then be cured from a liquid state to a substantially solid state.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a method for applying a traction coating to a bathing implement, constructed and operative according to the teachings of the present disclosure.

FIG. 1 is a front perspective view of the means of applying a traction coating to a bathing implement during an ‘in-use’ condition, according to an embodiment of the disclosure.

FIG. 2 is a front perspective view of the means of applying a traction coating to a bathing implement of FIG. 1, according to an embodiment of the present disclosure.

FIG. 3 is a front perspective view of the means of applying a traction coating to a bathing implement of FIG. 1, according to an embodiment of the present disclosure.

FIG. 4 is a front perspective view of the means of applying a traction coating to a bathing implement of FIG. 1, according to an embodiment of the present disclosure.

FIG. 5 is a flow diagram illustrating a method of applying a traction coating to a bathing implement, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a traction coating application and more particularly to a method/means for applying a traction coating to a bathing implement as used to improve the traction of the host bathing implement.

Generally, the method for applying a traction coating to a bathing implement involves acquiring a conventional bathing implement or coating of an existing bathing implement. The bathing implement may be purchased from a retail store or through a manufacturer. The bathing implement may embody a bathtub, shower stall, wash basin and similar residential fixtures used for washing that may require a traction surface. The present invention provides a method to apply a traction coating of silicon rubber or a composite thereof to the bathing implement.

Further, the method includes modifying the surface of the bathing implement. The surface may be modified by attaching an anatomically formed structure. The anatomically formed structure may provide additional support for people with special needs. The anatomically formed structure may be customized prior to application correspondingly to a client's request. The anatomically formed structure may further embody any structure that a client may request. The structure may embody a novelty children's toy, additional seating, organizational containers, and all further considered customized features that may be added to the bathing implement.

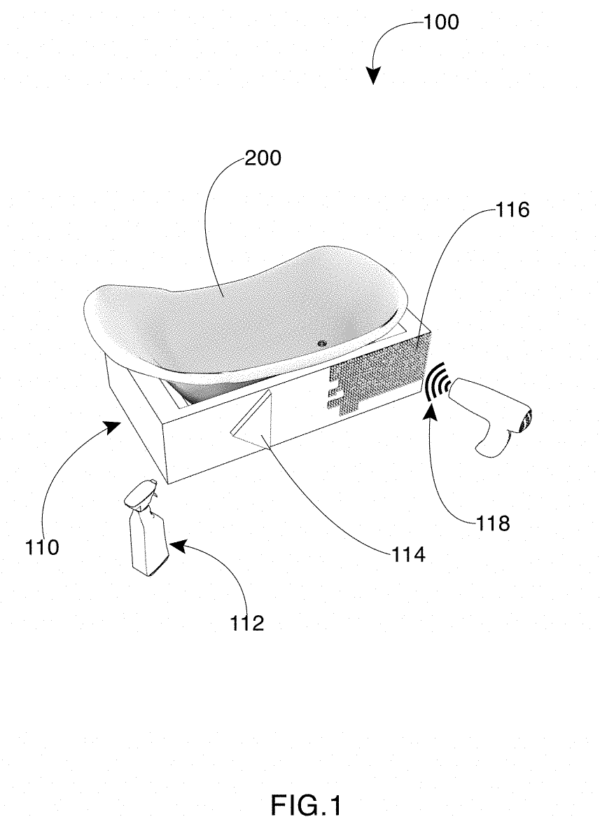

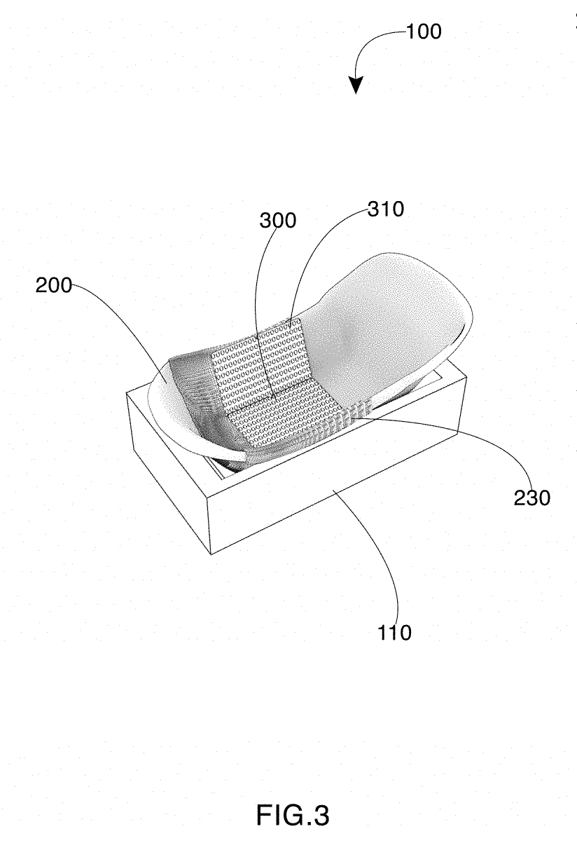

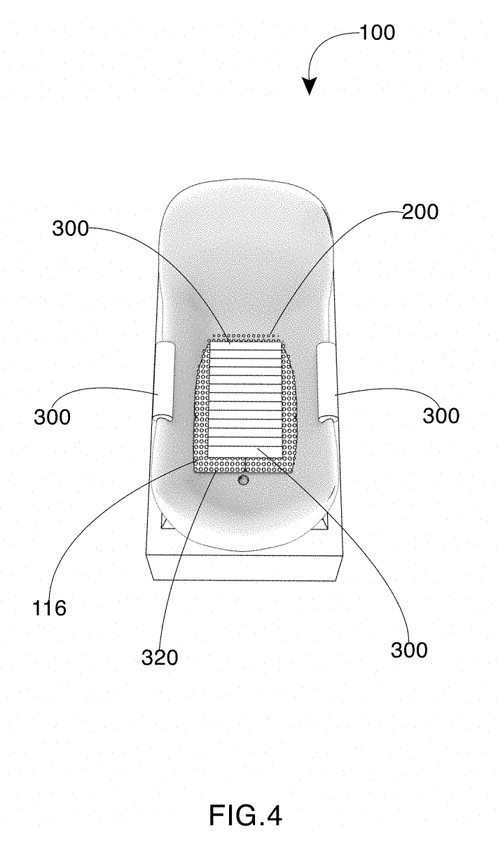

Referring now more specifically to the drawings by numerals of reference, there is shown in FIGS. 1-4, various views of applying a traction coating to a bathing implement 110.

The application of a traction coating to a bathing implement 110 is shown for an ‘in-use’ condition 50, according to an embodiment of the present disclosure. Here, the method 100 may be beneficial to apply a traction coating to a bathing implement 110 surface. As illustrated, the method 100 may include providing a bathing implement 110. The bathing implement 110 may embody a prefabricated bathtub, shower, and any similar facility used for washing. Cleaning at least one surface 200 of said bathing implement 110 with a cleaning agent 112. The process of cleaning is to remove any matter that may be on the at least one surface 200 of the bathing implement 110. Securing a stencil 114 to the at least one surface 200. The stencil 114 may be used to protect the at least one surface 200 from debris. The stencil 114 may have a design configured to increase traction. The stencil 114 may be coated in an oil to prevent the adherence of any material.

Applying a base coat of silicon rubber 116 to the at least one surface 200 measuring a thickness of 1 millimeter to a thickness of 4 millimeters is preferred. The base coat of silicon rubber 116 may be applied over the stencil 114. The stencil 114 may then be removed, and alternatively, remain secured to the at least once surface 200. Curing 118 the base coat of silicon rubber 116 such that the base coat of silicon rubber 116 transitions from a liquid state to a substantially solid state. The method of curing 118 may involve an additive reaction. The additive reaction may include adding additional chemicals to the base coat of silicon rubber 116 such that the base coat of silicon rubber 116 transitions from a liquid state to a substantially solid state. The method of curing 118 may involve vulcanization. The vulcanization may be completed by inputting energy through heat and light.

The method 100 may include providing a bathing implement 110. The bathing implement 110 may have a base coat of silicon rubber 116 applied to the at least one surface 200. A traction stencil 222 may be applied to the base coat of silicon rubber 116 during a substantially solid state. The traction stencil 222 may cover a traction area 220. The traction stencil 222 may have at least one surface 200 coated in oil. The oil may be configured to disallow the adherence of silicon rubber to said traction stencil 222. The traction stencil 222 may include voids configured to pool the second coat of silicon rubber 230. The voids may define the pattern used for increasing traction in the bathing implement 110. The pattern used for increasing traction may have any design. A second coat of silicon rubber 230 may be disposed over the traction area 220. The second coat of silicon rubber 230 may then be cured into a substantially solid state.

A further step in the method 100 may be to affix an anatomically formed structure 300 to the bathing implement 110. The anatomically formed structure 300 may be custom made to accommodate different body types. The anatomically formed structure 300 may embody any structure that may be affixed to the at least one surface 200 of the bathing implement 110. The anatomically formed structure 300 may be made of steel. The anatomically formed structure 300 may be made of plastic, and alternatively any composite thereof. The anatomically formed structure 300 may be attached to the bathing implement 110 prior to the base coat of silicon rubber 116 (FIG. 1) having been applied. The anatomically formed structure 300 may be affixed to the bathing implement 110 prior to, and alternatively, following the second coat of silicon rubber 230 being applied.

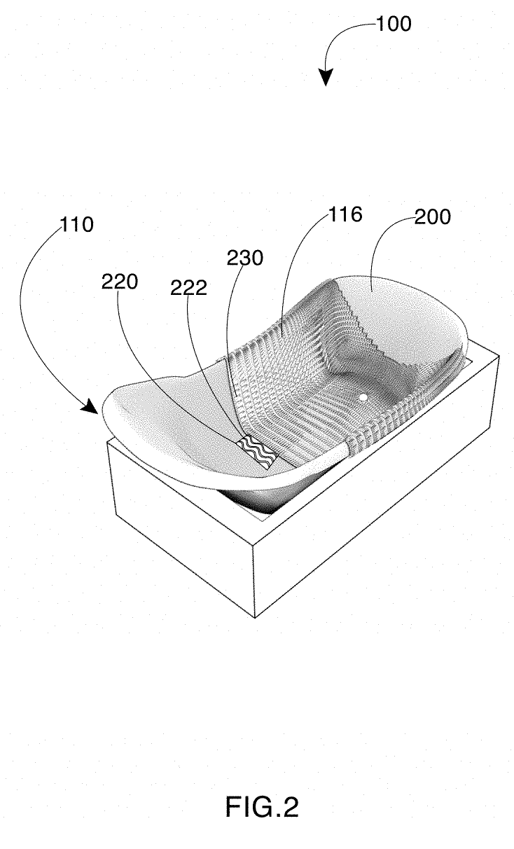

A third coating of silicon rubber 310 may be applied on the anatomically formed structure 300. The third coating of silicon rubber 310 may be applied directly to the anatomically formed structure 300. The third coating of silicon rubber 310 may be applied multiple times. The traction stencil 222 (FIG. 2) may be used in conjunction with the third coating of silicon rubber 310. The third coating of silicon rubber 310 is then cured into a substantially solid state. The curing 118 (FIG. 1) may be achieved through additive reaction, vulcanization, and any other means of curing 118.

As shown, the method 100 comprises a bathing implement 110 (FIG. 1) having a base coat of silicon rubber 116 applied to at least one surface 200. As shown, a granular material 320 may be mixed into the base coat of silicon rubber 116 prior to the step of curing 118 (FIG. 1) the base coat of silicon rubber 116. The granular material 320 may include silica sand. The granular material 320 effectively increases the traction of the base coat of silicon rubber 116. Further modifications of the base coat of silicon rubber may include the step of mixing a coloring agent into the base coat of silicon rubber 116 prior to the step of curing 118 the base coat of silicon rubber 116. Further shown are multiple instances of an anatomically formed structure 300. The anatomically formed structure 300 may be removably attachable to the bathing implement 110

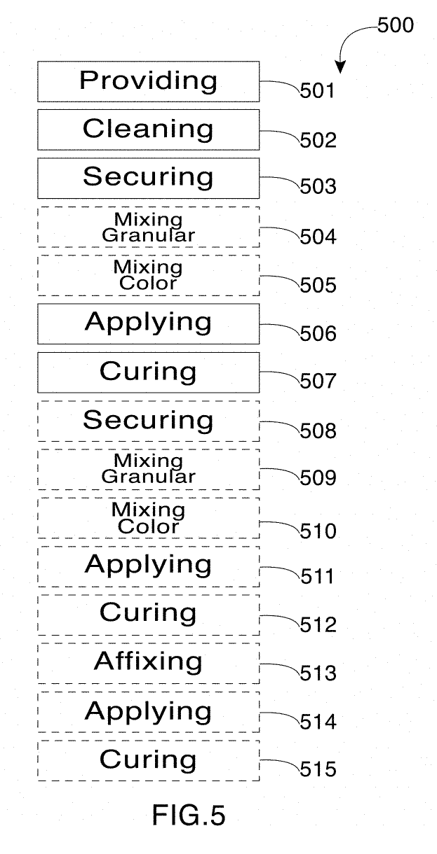

FIG. 5 is a flow diagram illustrating a method for applying a traction coating to a bathing implement 500, according to an embodiment of the present disclosure. In particular, the method for applying a traction coating to a bathing implement 500 may include one or more components or features of the method 100 as described above. As illustrated, the method for applying a traction coating to a bathing implement 500 may include the steps of: step one 501, providing a bathing implement; step two 502, cleaning at least one surface of said bathing implement with a cleaning agent; step three 503, securing a stencil to the at least one surface; step four 504, mixing granular material into the base coat of silicon rubber prior to the step of curing the base coat of silicon rubber; step five 505, mixing a coloring agent into the base coat of silicon rubber prior to the step of curing the base coat of silicon rubber; step six 506, applying a base coat of silicon rubber to the at least one surface measuring a thickness of 1 millimeter to a thickness of 4 millimeters; step seven 507, curing the base coat of silicon rubber such that the base coat of silicon rubber transitions from a liquid state to a substantially solid state; step eight 508, securing a traction stencil to the base coat of silicon rubber during a substantially solid state, the traction stencil covering a traction area; step nine 509, mixing granular material into the second coat of silicon rubber prior to the step of curing the second coat of silicon rubber; step ten 510, mixing a coloring agent into the second coat of silicon rubber prior to the step of curing the second coat of silicon rubber; step eleven 511, applying a second coat of silicon rubber over the traction area; step twelve 512, curing the second coat of silicon rubber into a substantially solid state; step thirteen 513, affixing an anatomically formed structure to the bathing implement; step fourteen 514, applying a third coating of silicon rubber on the anatomically formed structure; step fifteen 515, curing the third coating of silicon rubber into a substantially solid state;

It should be noted that step 504, 505, 508, 509, 510, 511, 512, 513, 514, and 515 are optional steps and may not be implemented in all cases. Optional steps of method of use 500 are illustrated using dotted lines in FIG. 5 so as to distinguish them from the other steps of method of use 500. It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for applying a traction coating to a bathing implement, are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A method for applying a traction coating to a bathing implement, the method for applying a traction coating comprising:
providing a bathing implement;
cleaning at least one surface of said bathing implement with a cleaning agent;
securing a stencil to the at least one surface;
applying a base coat of silicon rubber to the at least one surface measuring a thickness of 1 millimeter to a thickness of 4 millimeters; and
curing the base coat of silicon rubber such that the base coat of silicon rubber transitions from a liquid state to a substantially solid state;

2. The method for applying a traction coating of claim 1, further including the step of securing a traction stencil to the base coat of silicon rubber during a substantially solid state, the traction stencil covering a traction area.
wherein said traction stencil has at least one surface coated in oil, the oil configured to disallow the adherence of silicon rubber to said traction stencil.

3. The method for applying a traction coating of claim 2, further including the step of applying a second coat of silicon rubber over the traction area.

4. The method for applying a traction coating of claim 3, further including the step of curing the second coat of silicon rubber into a substantially solid state.

5. The method for applying a traction coating of claim 1, further including the step of affixing an anatomically formed structure to the bathing implement.

6. The method for applying a traction coating of claim 5, further including the step of applying a third coating of silicon rubber on the anatomically formed structure.

7. The method for applying a traction coating of claim 6, further including the step of curing the third coating of silicon rubber into a substantially solid state.

8. The method for applying a traction coating of claim 1, further including the step of mixing granular material into the base coat of silicon rubber prior to the step of curing the base coat of silicon rubber.

9. The method for applying a traction coating of claim 3, further including the step of mixing granular material into the second coat of silicon rubber prior to the step of curing the second coat of silicon rubber.

10. The method for applying a traction coating of claim 1, further including the step of mixing a coloring agent into the base coat of silicon rubber prior to the step of curing the base coat of silicon rubber.

11. The method for applying a traction coating of claim 3, further including the step of mixing a coloring agent into the second coat of silicon rubber prior to the step of curing the second coat of silicon rubber.

12. The method for applying a traction coating of claim 2, wherein the traction stencil includes voids configured to pool the second coat of silicon rubber.

13. The method for applying a traction coating of claim 9, wherein the granular material includes silica sand.

14. The method for applying a traction coating of claim 1, wherein the step of curing involves an addition reaction.

15. The method for applying a traction coating of claim 1, wherein the step of curing involves vulcanization.

16. The method for applying a traction coating of claim 1, wherein the anatomically formed structure is removable from the bathing implement.

17. A method for applying a traction coating, the method comprising:
providing a bathing implement,
cleaning at least one surface of said bathing implement with a cleaning agent,
securing a stencil to the at least one surface,
applying a base coat of silicon rubber to the at least one surface measuring a thickness of 1 millimeter to a thickness of 4 millimeters,
curing the base coat of silicon rubber such that the base coat of silicon rubber transitions from a liquid state to a substantially solid state;
further including the step of securing a traction stencil to the base coat of silicon rubber during a substantially solid state, the traction stencil covering a traction area;
wherein said traction stencil has at least one surface coated in oil, the oil configured to disallow the adherence of silicon rubber to said traction stencil;
further including the step of applying a second coat of silicon rubber over the traction area;
further including the step of curing the second coat of silicon rubber into a substantially solid state;
further including the step of affixing an anatomically formed structure to the bathing implement;
further including the step of applying a third coating of silicon rubber on the anatomically formed structure;
further including the step of curing the third coating of silicon rubber into a substantially solid state;
further including the step of mixing granular material into the base coat of silicon rubber prior to the step of curing the base coat of silicon rubber;
further including the step of mixing granular material into the second coat of silicon rubber prior to the step of curing the second coat of silicon rubber;
further including the step of mixing a coloring agent into the base coat of silicon rubber prior to the step of curing the base coat of silicon rubber;
further including the step of mixing a coloring agent into the second coat of silicon rubber prior to the step of curing the second coat of silicon rubber;
wherein the traction stencil includes voids configured to pool the second coat of silicon rubber;
wherein the granular material includes silica sand;
wherein the step of curing involves an addition reaction;
wherein the step of curing involves vulcanization;
wherein the anatomically formed structure is removable from the bathing implement;
